(19) United States
(12) Patent Application Publication
(10) Pub. No.: US 2016/0325419 A1
(43) Pub. Date: Nov. 10, 2016

(54) Work Tool

(71) Applicant: HILTI AKTIENGESELLSCHAFT, Schaan (LI)

(72) Inventors: Thomas SPERRFECHTER, Gruesch (CH); Markus WOERNER, Hergensweiler (DE)

(73) Assignee: Hilti Aktiengesellschaft, Schaan (LI)

(21) Appl. No.: 15/106,211

(22) PCT Filed: Dec. 17, 2014
(86) PCT No.: PCT/EP2014/078114

§ 371 Date: Jun. 17, 2016

(30) Foreign Application Priority Data
Dec. 20, 2013 (EP) 13198803.2

(51) Int. Cl. B25C 1/00; B25C 1/08

(52) U.S. Cl. CPC B25C 1/005; B25C 1/008; B25C 1/08

(57) ABSTRACT

A work tool for driving a securing element into a substructure is disclosed. The work tool includes a guide channel for the securing element, a piston that is pushable towards the securing element proceeding from a starting position in which the piston is at rest, so as to transmit energy to the securing element arranged in the guide channel, a feed device for conveying the securing element into the guide channel, and a feed-delay device for delaying the securing element being conveyed into the guide channel until the piston has returned into the starting position following a driving process.

This application claims the priority of International Application No. PCT/EP2014/078114, filed Dec. 17, 2014, and European Patent Document No. 13198803.2, filed Dec. 20, 2013, the disclosures of which are expressly incorporated by reference herein.

### BACKGROUND AND SUMMARY OF THE INVENTION

The invention relates to a work tool for driving a securing element into a substructure.

Work tools for driving securing elements into substructures often have a guide channel for the securing element; a piston, which can be pushed towards the securing element proceeding from a starting position in which the piston is at rest, so as to transmit energy to the securing elements arranged in the guide channel; and a feed device for conveying the securing element into the guide channel. There are also known work tools with a feed-delay device for delaying the securing element being conveyed into the guide channel.

A hand-operated setting tool is described in DE 10 2007 000 025, where the piston activates the feed device when it has moved backwards, after a setting process behind the guide channel. However, there is a risk of the piston moving back and forth and repeatedly activating the feed device, so that under certain circumstances several securing elements will exist in the guide channel simultaneously, which can lead to an obstruction of the guide channel.

The objective of this invention is to present a work tool that reduces the risk of such an obstruction.

The invention relates to a work tool for driving a securing element into a substructure, comprising: a guide channel for the securing element; a piston which can be pushed towards securing element proceeding from a starting position in which the piston is at rest, so as to transmit energy to the securing element arranged in the guide channel; a feed device for conveying the securing element into the guide channel; and a feed-delay device for delaying the securing element being conveyed into the guide channel until the piston has returned into the starting position following a driving process. This ensures that the feeding of the securing element is delayed until, if applicable, any back-and-forth movement of the piston has terminated.

In accordance with an advantageous embodiment, the feed-delay device has a release position, in which it allows the securing element to be conveyed into the guide channel when the piston is arranged in the starting position, and a blocking position in which it blocks the conveying of the securing element into the guide channel when the piston is arranged outside of the starting position.

In accordance with an advantageous embodiment, the work tool has a detection device, which determines whether the piston is arranged in the starting position.

In accordance with an advantageous embodiment, the work tool has a drive device for pushing the piston towards the securing element and a trip device whose activation triggers the pushing of the piston towards the securing element.

In accordance with an advantageous embodiment, the work tool has a pressing device, which determines whether the work tool is pressed onto a substructure and which is arranged in a pressing position when the work tool is pressed onto a substructure. Preferably, the pressing device permits the pushing of the piston towards the securing element only in the pressing position.

Equally preferably, the drive device has a combustion chamber, which is expanded by the pressing device when the work tool is pressed onto a substructure. Especially preferably, after a driving process, the detection device only allows the collapsing of the expanded combustion chamber when the piston is arranged in the starting position, whereas the detection device blocks the collapsing of the expanded combustion chamber when the piston is not arranged in the starting position.

In accordance with an advantageous embodiment, the feed-delay device is moved from the release position into the blocking position when the work tool is pressed onto a substructure and/or when the combustion chamber is expanded. In accordance with a further advantageous embodiment, the feed-delay device is moved from the blocking position into the release position when the combustion chamber collapses.

In accordance with an advantageous embodiment, the work tool has a cartridge for receiving the securing element, for which the feed device is provided to convey the securing element from the cartridge into the guide channel.

In accordance with an advantageous embodiment, the feed-delay device has a lever, which in the blocking position is projected into the conveying path or lies flat against the securing element, and which in the release position is separated from the conveying path and the securing element. Preferably, the lever has a contact surface for force-closed and/or form-closed contact against the securing element. Equally preferably, the lever is designed as a pivoting lever. Especially preferably, the lever can be rotated on an axis of rotation against a housing and/or a nib of the work tool, especially mounted on the guide channel or on the cartridge.

### BRIEF DESCRIPTION OF THE DRAWINGS

FIG. 1 depicts a schematic axial cross-section of a work tool with collapsed partial combustion chambers;

FIG. 2 depicts a schematic axial cross-section of the work tool in FIG. 1 in the pressed condition with expanded partial combustion chambers;

FIG. 3 depicts a schematic axial cross-section of the work tool in FIG. 2 during ignition;

FIG. 4 depicts a schematic axial cross-section of the work tool in FIG. 3 during the return of the piston;

FIG. 5 depicts a schematic axial cross-section of the work tool in FIG. 4 after the return of the piston;

FIG. 6 depicts a schematic axial cross-section of the work tool in FIG. 5 during the collapsing of the partial combustion chamber;

FIG. 7 depicts a nib of a work tool from the side view;

FIG. 8 depicts a nib of a work tool from the side view;

FIG. 9 depicts a nib of a work tool from the side view;

FIG. 10 depicts a nib of a work tool from an angle;

FIG. 11 depicts a nib of a work tool from an angle;

FIG. 12 depicts a feed-delay device; and

FIG. 13 depicts a feed-delay device.

### DETAILED DESCRIPTION OF THE DRAWINGS

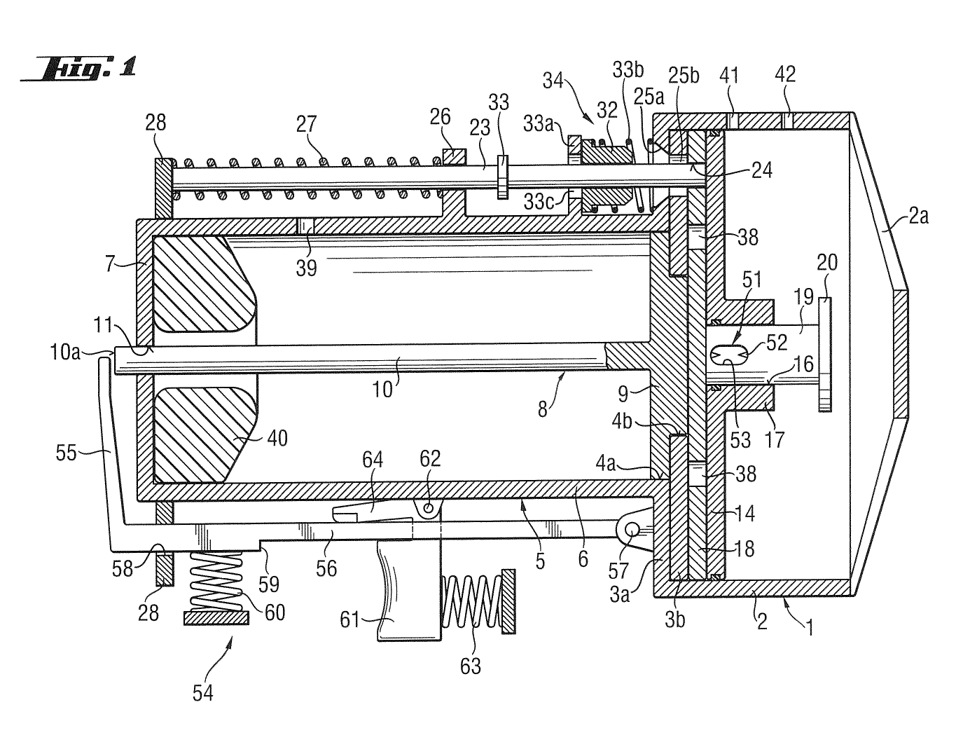

FIG. 1 shows an axial cross-section of a combustion-driven setting tool for securing elements in the area of its combustion chamber. According to FIG. 1, the setting tool contains a cylindrically shaped combustion chamber (1) with a cylinder wall (2) and a ring-shaped bottom wall (3a, 3b) attached to it. In the center of the bottom wall (3a, 3b) there is an opening (4a, 4b) to which a guide cylinder (5) is attached, which has a cylinder wall (6) and a bottom wall (7). Within the guide cylinder (5) a piston (8) is positioned, which smoothly glides in the longitudinal direction of the guide cylinder (5). The piston (8) consists of a piston plate (9) pointed towards to the combustion chamber (1) and a plunger (10) joined centrally to the piston plate (9) that partially protrudes from the guide cylinder (5) through a passage opening (11) in the bottom wall (7).

In FIG. 1, the piston (8) is in its retracted resting position or starting position, respectively, in which the setting tool is not in operation. The side of the piston plate (9) facing the combustion chamber (1) ends more or less with the inside of the bottom wall (3a, 3b), and the plunger (10) projects out above the bottom wall (7) only slightly. The piston plate (9) tapers stepwise in the direction of the combustion chamber (1), whereupon the part with the smaller diameter comes to rest in the opening (4b) and the part with the larger diameter comes to rest in the opening (4a). The part of the piston plate (9) with the larger diameter thus strikes against the bottom wall (3b), which serves as an end stop for the piston plate (9) when the piston (8) is in its starting position. Though not represented in the illustration, sealing rings on the outer periphery of the piston plate (9) can be incorporated in order to seal off the rooms from one another on both sides of the piston plate (9). Within the combustion chamber (1) there is a cylinder plate (14) which can be described as the combustion chamber wall. The combustion chamber wall (14) can be moved in the longitudinal direction of the combustion chamber (1) and has a ring-shaped seal on its outer peripheral rim in order to seal off the rooms in front of and behind the combustion chamber wall (14). Further, the combustion chamber wall (14) has a central passage opening (16) with a ring-shaped peripheral seat

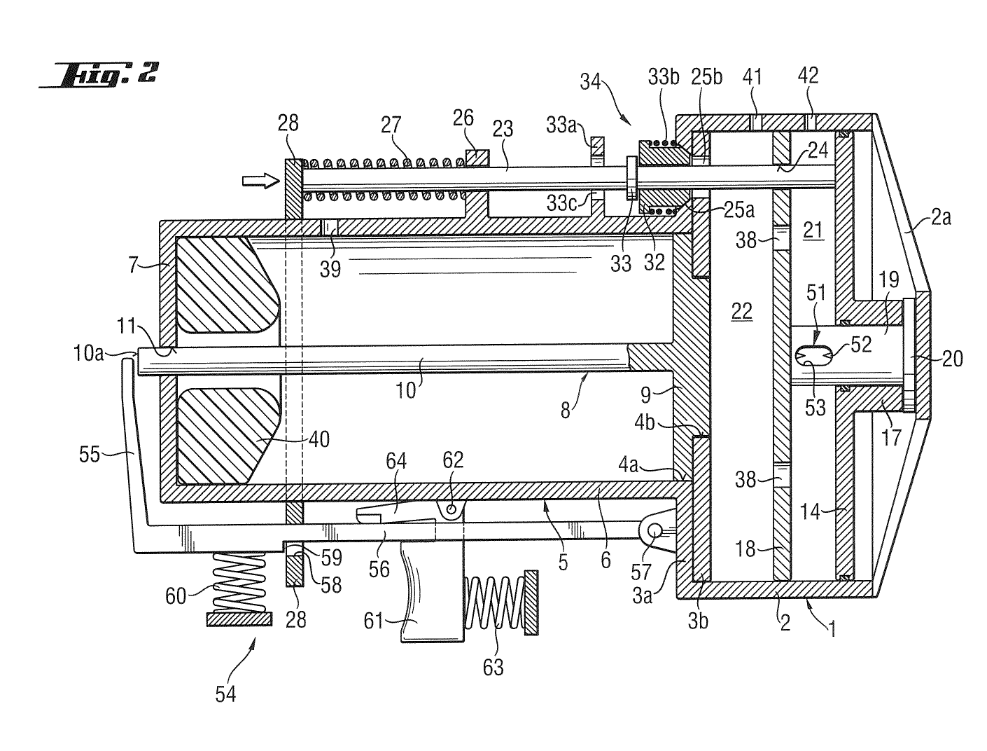

Between the combustion chamber wall (14) and the bottom wall (3b) there is an additional partition plate (18). The partition plate (18) is similarly formed in a circular shape and has an external diameter that corresponds to the internal diameter of the combustion chamber (1). On the side facing the combustion chamber wall (14), the partition plate (18) is joined to a cylindrical extension (19), which protrudes through the central passage opening (16) of the combustion chamber wall (14) and whose length corresponds to several times the width of the combustion chamber wall (14). The aforementioned peripheral seal along the passage opening (16) is closely nestled to the outer peripheral surface of the cylindrical extension (19). At its upper end the cylindrical extension (19) has a ring-shaped extension (20) that projects beyond its circumference. The external diameter of the ring-shaped extension (20) is larger than the internal diameter of the passage opening (16). On the edge of the passage opening (16) a hollow cylindrical extension (17) is attached to the combustion chamber wall (14) and surrounds the cylindrical extension (19). The free end of the hollow cylindrical extension (17) lies opposite to the lower side of the ring-shaped extension (20) and is separated from it in FIG. 1. A ridge (2a) connected to the cylinder wall (2) serves as an end stop for the extension (19) and thus for the positioning of the partition plate (18) connected to the extension (19) upon expansion of the combustion chamber. The ridge (2a) is only fully illustrated in FIG. 1 and is not depicted in FIG. 2 to FIG. 6 for the sake of clarity.

In the resting state of the work tool according to FIG. 1, the partition plate (18) lies on the bottom wall (3b) and the combustion chamber wall (14) lies on the partition plate (18). The combustion chamber (1) is thus fully collapsed. Upon the attachment of the tool to an object (not shown) into which a securing element is to be driven, the combustion chamber wall (14) is raised and thus separated from the partition plate (18) and the bottom wall (3b), respectively. This process will be further explained below. The combustion chamber wall (14) thus takes the partition plate (18) along with it over the ring-shaped extension (20) after a certain amount of time. Throughout this process, the combustion chamber wall (14) and the partition plate (18) are separated from each other by a predetermined distance, which is determined by the position of the ring-shaped extension (20). In doing so, the combustion chamber wall (14) and partition plate (18) form a so-called antechamber. This represents a partial combustion chamber within the combustion chamber (1). This antechamber is denoted by the reference number (21) in FIG. 2. If the combustion chamber wall (14) is raised further, the combustion chamber wall (14) and the partition plate (18) move parallel to one another, so that between the partition plate (18) and the bottom wall (3b) and piston plate (9), respectively, an additional partial combustion chamber is expanded, which is described as the main chamber. This partial combustion chamber, i.e., main chamber, is denoted by the reference number (22) in FIG. 2. FIG. 2 illustrates the condition in which both partial combustion chambers (21) and (22) are fully expanded. The extension (19) now also strikes against the end stop and the ridge (2a), respectively.

For moving the combustion chamber wall (14) in the longitudinal direction of the combustion chamber (1), spaced in equal angular distance along the periphery of the combustion chamber wall (14) are attached, for example, three drive bars (23), of which only one can be seen in the illustration. The drive bars (23) lie parallel to the cylindrical longitudinal axis of the combustion chamber (1) and lateral to the exterior of the cylinder wall (6). Each of the drive bars (23) thus traverses one passage opening (24) in the partition plate (18) as well as an additional passage opening (25a, 25b) in the bottom wall (3a, 3b). This passage opening (25a, 25b) is also formed as a valve opening and has a conical shape in the area of (25a). The drive bars (23) and the combustion chamber wall (14) are connected to one another, for example in a suitable manner with bolts, while the free ends of the drive bars (23) are connected to one another over the drive ring (28), which lies concentrically to the cylindrical axis of the combustion chamber and encircles the guide cylinder (5). The drive ring (28) can also be bolted to the drive bars (23) with bolts. Between the drive ring (28) and the extensions (26) attached to the exterior of the cylinder wall (6), through each of which one of the drive bars (23) traverses, a compression spring (27) lies on each of the drive bars (23), which bear on the respective extension (26) and push against the drive ring (28). The task of these compression springs (27) is to continually push the combustion chamber wall (14) in the direction of the bottom wall (3b).

As mentioned previously, the passage opening (25a, 25b), which serves as a valve opening and expands conically on the exterior (25a), is located in the area of the ring-shaped bottom wall (3a, 3b). A valve lifter (32) can be inserted into the valve opening as a sealant. When the valve opening (25a, 25b) is open, this valve lifter (32) lies outside of the combustion chamber (1) and underneath the bottom wall (3a), respectively, and is blocked in this position by an extension (33a) attached to the guide cylinder (5). Between the valve lifter (32) and the edge of the opening (25a) lies a compression spring (33b), which pushes the valve lifter against the extension (33a). If the drive ring (28) is pushed in the direction of the bottom wall (3a), an extension (33) attached to the drive bar takes the valve lifter (32) along with it and inserts it into the valve opening (25a, 25b) against the pressure of the spring (33b), in order to close the valve bearing the reference number (34). This represents an inlet/outlet valve. In doing so, the extension (33) traverses an opening (33c) available in the extension (33a).

It should be mentioned that the partition plate (18) has several passage openings (38) on its periphery, which can have the same distance each from the cylindrical axis of the combustion chamber (1). Further, there are outlet openings (39) on the bottom end of the guide cylinder (5) for letting air out of the guide cylinder (5) when the piston (8) is moved in the direction of the bottom wall (7). Moreover, on the bottom end of the guide cylinder (5) there is a damping device (40) for damping the movement of the piston (8). If the piston (8) traverses the outlet openings (39), gas can escape from the outlet openings (39). In the cylinder wall (2) and the combustion chamber (1) there are also two radial passage openings (41) and (42), which are separated from one another in an axial direction. Liquid combustion gas can be injected through them into the not yet fully expanded partial combustion chambers (21) and (22), using dosing valves that can be attached to the passage openings (41) and (42). In this manner, the volume of combustion gas mixture can be set to dose into the partial combustion chambers (21) and (22), respectively.

As already mentioned, FIG. 2 shows the setting tool (10) in the expanded condition of the partial combustion chambers, i.e., in the expanded condition of the antechamber (21) and the main chamber (22). The pushing positions of the combustion chamber wall (14) and the partition plate (18) are positioned in such a way that, upon entering the valve opening (25a, 25b), the valve lifter (32) stops the extension (33) and with it the drive bars (23), so that the combustion chamber wall (14) is also stopped. The position of the partition plate (18) is the result of the extension (19) thrusting against the end stop (2a). The valve lifter (32) has a conical embodiment. It should also be mentioned that the central extension (19) attached to the partition plate (18) is formed as an ignition bracket (51) in the area facing the partition plate (18) in order to receive an ignition device (52). This ignition device (52) serves to produce an electrical spark for the purpose of igniting a combustion gas mixture in the antechamber (21). As will be described further below, the ignition device (52) is located in the internal and/or in a central area of the ignition bracket (51), which is equipped with passage openings (53) on its periphery, through which a laminar flame front can exit from the ignition cage (51) into the antechamber (21).

As FIG. 1 also depicts, a locking and unlocking device (54) is arranged next to the guide cylinder (5) and is attached to a detection device comprising a sensor element (55) for determining the pushing position of the piston (8) and the plunger (10), respectively, i.e., whether the piston (8) is arranged in the starting position. The locking and unlocking device (54) serves to lock the drive ring (28) and thus to lock the inlet/outlet valve (34) in the closed position. For this purpose, the locking and unlocking device (54) has a locking lever (56), which passes externally in close proximity to the cylinder wall (6) parallel to the longitudinal direction of the cylinder (5) and is attached by its back end to the external side of the bottom wall (3a) in such a way that it can be pivoted. For this purpose, a bearing device (57) is located there. The end of the locking lever (54) that faces away from the bearing device (57) traverses an opening (58) in the drive ring (28) and then proceeds integrally into the sensor element (55), whose free end stretches into the path of the plunger (10). The free end of the sensor element (55) thus comes to lie immediately in front of the end face (10a) of the plunger (10) when the piston (8) is in its starting position according to FIG. 1. The locking lever (56) and the sensor element (55) can, for example, be stamped out of a sufficiently strong sheet metal. On its side that faces away from the cylinder (5) the locking lever (56) has a locking edge (59), with which the locking lever can grasp behind the drive ring (28) when it has been sufficiently far pushed in the direction of the bottom wall (3a). Starting from the bearing device (57), the locking lever (56) thus initially has a relatively small width, which is then enlarged to create the locking edge (59). With the assistance of a compression spring (60) mounted on the side of the housing, the locking lever (56) is pivoted around the bearing device (57) in the direction of the cylinder (5) such that the locking edge (59) is disengaged with the edge of the opening (58) and the free end of the sensor section (55) lies in the path of the plunger (10).

Further, on the side of the cylinder (5) there is a trip device (61) designed as a trigger, which is positioned to the exterior of the cylinder wall (6) in such a way that it can be pivoted. For this purpose, a bearing device (62) is provided. The trigger (61) can be pivoted around the bearing device (62) in the direction of the bottom wall (3a, 3b), namely against the thrust of a compression spring (63). In doing so, an operating section of the trigger (61) comes to lie outside of the locking lever (56). Further, in the area of the bearing device (62) the trigger (61) is, for example, integrally connected to an extension (64) pointing towards the floor (7) of the cylinder (5). If, as a result, the trigger (61) in FIG. 1 moves counter-clockwise around the bearing device (62), the extension (64) will be taken along accordingly, which acts upon the edge of the locking lever (56) pointing towards the cylinder (5) and then correspondingly takes the cylinder along against the force of the spring (60) and pivots it around the bearing device (57), respectively.

The functional operation of the invented work tool will subsequently be explained further according to the first exemplary embodiment with reference to FIG. 2 to FIG. 6. Elements that are the same in FIG. 1 bear the same reference numbers and will not be described again.

FIG. 2 shows a condition in which the work tool has been pressed with its point against an object into which a securing element is to be driven. In doing so, the drive ring (28) is pushed in the direction of the combustion chamber (1) over a front-facing pressing bracket (not shown) and thus expands the partial combustion chambers (21) and (22) over the drive bars (23), whereupon the inlet/outlet valve (34) is sealed. The pressing bracket, the drive ring (28), the drive bars (23), and the compression springs (27) essentially form a pressing device of the work tool, which can be seen in a pressing position in FIG. 2. The pressing device only allows the pushing of the piston (8) in the pressing position. Shortly before the partial combustion chambers (21) and (22) have been fully expanded, liquid combustion gas is injected through the passage openings (41) and (42). The drive ring (28) comes to lie in the pressed end position in front of the locking edge (59), however, the locking edge (59) cannot yet grasp behind the drive ring (28), because the trigger (61) has not yet been activated. The free end of the sensor element (55) thus remains initially in the path of the plunger (10), i.e., immediately in front of its free end face (10a).

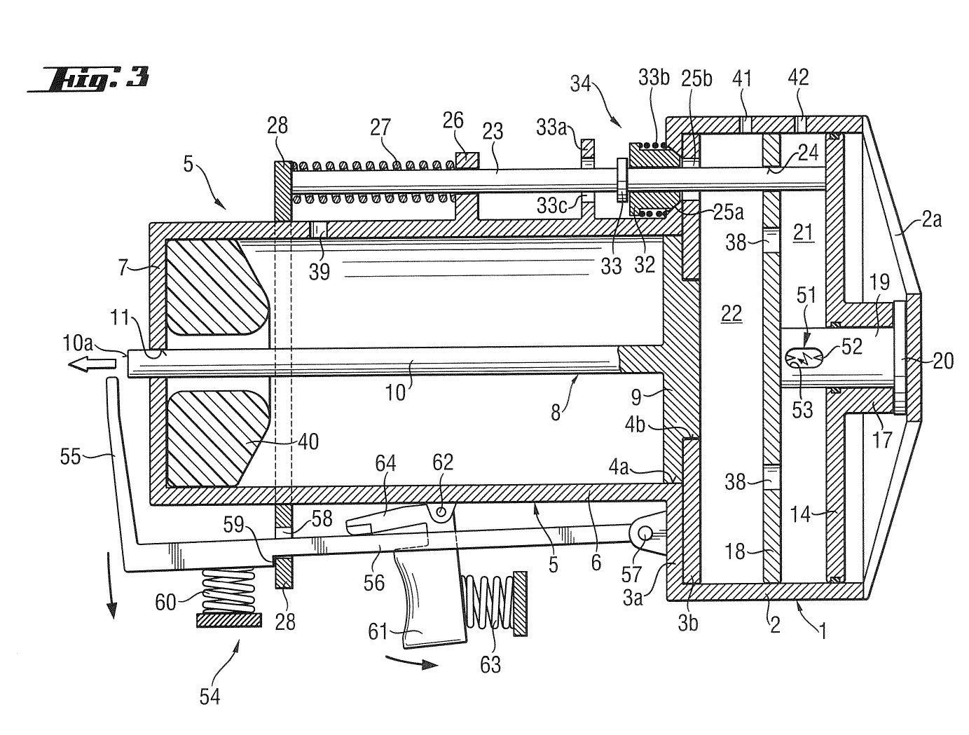

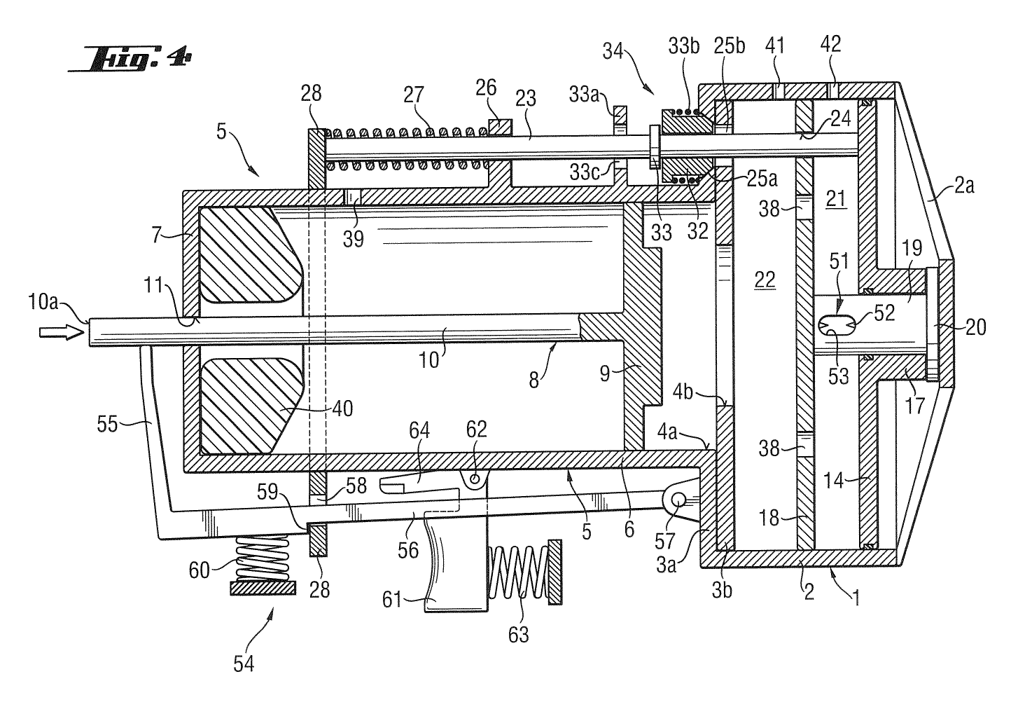

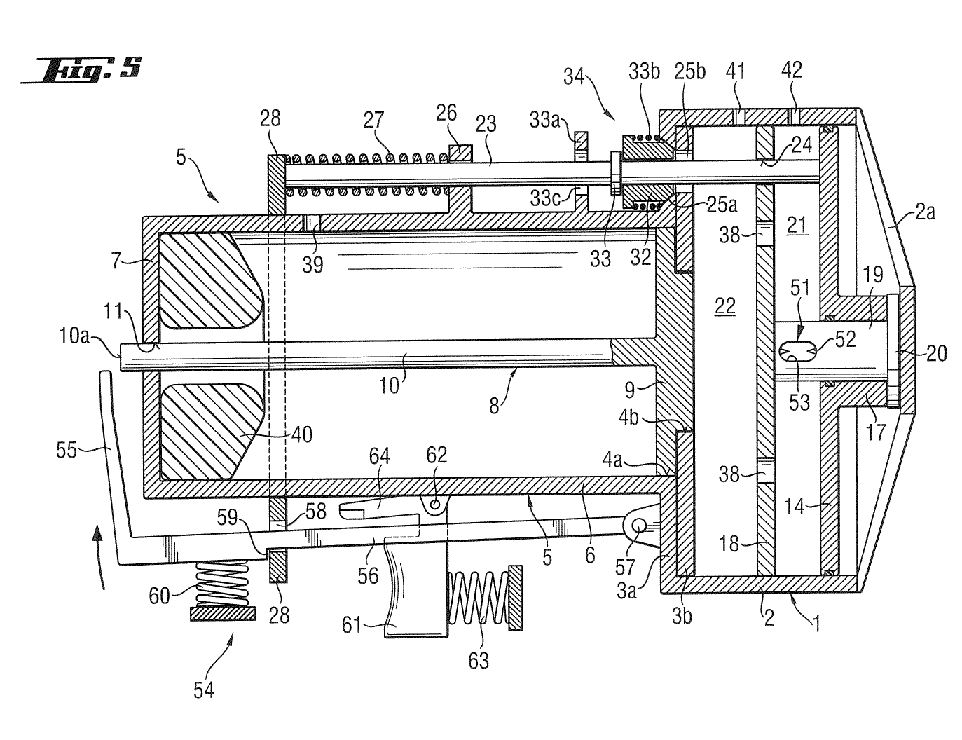

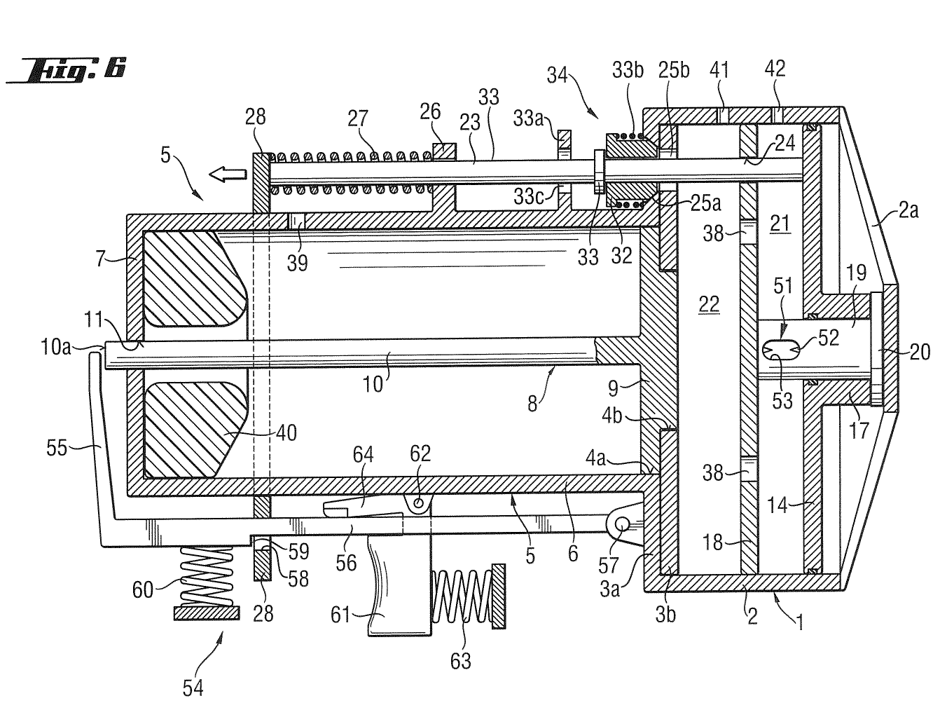

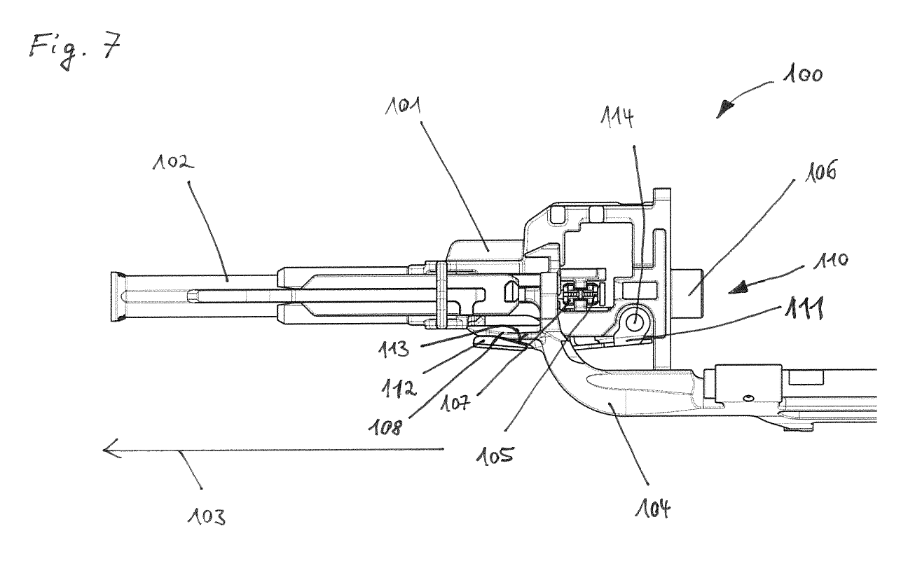

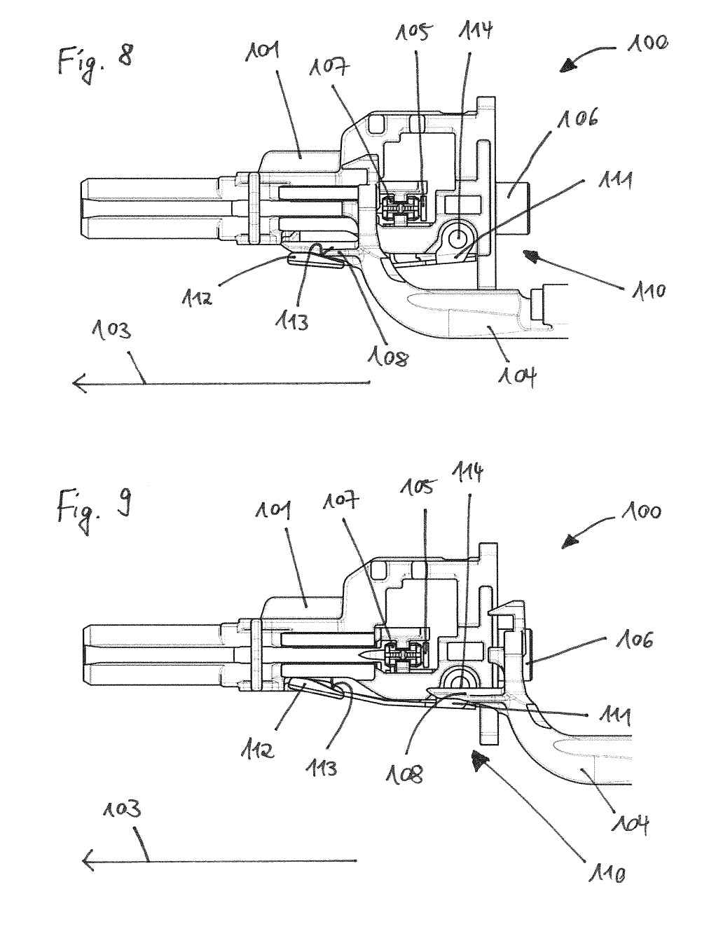

According to FIG. 3, the trigger (61) has now been activated, i.e., pivoted counter-clockwise around the bearing axis (62), namely against the force of the spring (63). In doing so, the locking lever (56) is pivoted counter-clockwise around the bearing axis (57) over the extension (64), so that the locking edge (59) grasps behind the drive ring (28). Simultaneously the sensor element (55) is moved out of the path of the plunger (10) with the pivoting of the locking lever (56). In the last section of the pivoting motion of the trigger (61), and after the sensor element (55) has been moved out of the path of the plunger (10), ignition of the combustion gas mixture present in the partial combustion chambers (21) and (22) occurs with the assistance of the ignition device (52). An ignition spark is thus produced through the electrical ignition device (52) within the ignition bracket (51). The mixture of, for example, air and combustion gas predetermined through dosing in each of the partial combustion chambers (21) and (22) initially begins to combust in a laminar manner in the antechamber (21), whereupon the flame front spreads out with relatively slow speed radially in the direction of the passage opening (38). In doing so, it pushes the non-combusted mixture of air and combustion gas forward, which reaches the main chamber (22) through the passage opening (38) and produces turbulence as well as pre-compression there. If the flame front reaches the passage opening (38) to the main chamber (22), the flames will cross over into the main chamber (22) as flame jets caused by the relatively small diameters of the passage openings (38) and produce additional turbulence there. The thoroughly mixed turbulent mixture of air and combustion gas in the main chamber (22) is ignited over the entire surface of the flame jets. It now burns with a high speed, which leads to a strong increase in pressure in the main chamber (22).

This high pressure is transmitted to the piston plate (9), such that it moves with high speed in the direction of the bottom wall (7), whereupon the air is simultaneously pushed out of the guide cylinder (5) through the outlet opening (39). The piston plate (9) temporarily traverses the outlet opening (39) so that gas can escape through it. Through the plunger (10) that extends in the direction of the arrow, a securing element is now set and/or driven into the object against which the work tool has been pressed. The combustion chamber (1), the ignition device (52), and further elements thus form a drive device for pushing the piston towards the securing element.

Shortly after the ignition of the combustion gas mixture in FIG. 3, the trigger (61) can again be released. Upon the aforementioned movement of the plunger (10) in the direction of the arrow in FIG. 3, the locking lever (56) and with it the sensor element (55) are pressed by the compression spring (60) in the direction of the guide cylinder (5). However, the locking edge (59) is not disengaged from the drive ring (28), because the free end of the sensor element (55) is only pressed against the periphery of the plunger (10), and therefore a pivoting of the locking lever (56) counter-clockwise around the bearing device (57) is not possible. The drive ring (28) retains its position, such that the inlet/outlet valve (34) remains closed and the partial combustion chambers (21, 22) remain expanded.

FIG. 4 shows a condition after the setting and successful combustion of the mixture of air and combustion gas in the main chamber (22), whereupon the piston (8) is led back to its starting position through thermal feedback, as indicated by the arrow in the illustration, because through the cooling of the flue gas remaining in the combustion chamber (1) and in the guide cylinder (5) a vacuum is created behind the piston (8) and behind the piston plate (9), respectively. The free end of the sensor element (55) continues to drag on the peripheral surface of the plunger (10), such that the drive ring (28) continues to remain locked over the locking edge (59). The inlet/outlet valve (34) remains sealed, because the piston (8) has not yet fully reached its starting position.

FIG. 5 shows a condition in which the piston (8) has been fully returned to its starting position through thermal feedback. Here, the openings (4a) and (4b) are fully closed by the piston plate. The free end (10a) of the plunger (10) has now been retracted so far into the guide cylinder (5) that this free end (10a) comes to lie outside of the area of the sensor element (55).

According to FIG. 6, the compression spring (60) can now pivot the locking lever (56) and with it the sensor element (55) counter-clockwise around the bearing device (57), such that the locking edge (59) of the locking lever (56) becomes disengaged from the drive ring (28).

In a next step, which is not illustrated, the drive ring (28) can now be pushed away from the bottom wall (3a, 3b) with the assistance of the compression springs (27), which leads the drive bars (23) to be carried along correspondingly. The extension (33) thus moves similarly away from the bottom wall (3a, 3b), so that the valve lifter (32) can be led out of the valve opening (25a, 25b), namely under the influence of the compression spring (33b). During the pushing of the drive bars (23) in the direction of the front end of the work tool, the combustion chamber wall (14) and the partition plate (18) are initially taken along correspondingly, such that the entire combustion chamber (1) and the partial combustion chambers (21, 22) collapse, respectively. In doing so, the combusted residual gases are discharged through the inlet/outlet valve (34). This inlet/outlet valve (34) also serves the delivery of fresh air into the combustion chamber (1) upon opposing movement of the plates of (14) and (18), as shown in FIG. 1. There can be several inlet/outlet valves present and controlled correspondingly.

FIG. 7 shows a nib (100) of a work tool, for example the work tool illustrated in FIG. 1 to FIG. 6. The nib (100) includes a holder (101) which has a guide channel designed as a bolt guide (102), where the bolt guide is movable in the driving direction (103) towards the holder. A pressing bracket (104) similarly movable in the driving direction (103) is mounted on the holder (101) and can be shifted by the bolt guide (102) against the driving direction (103) over an end stop. Because the holder (101) is firmly connected to a housing of the work tool that is not illustrated, the bolt guide (102) serves as a pressing sensor and is, together with the pressing bracket (104), a part of the pressing device of the work tool. When the work tool is pressed onto a substructure, the bolt guide (102) pushes, for example, the drive ring (28) over the pressing bracket (104) towards the combustion chamber (1), which is expanded by this action. In exemplary embodiments that are not illustrated, the pressing bracket stretches over the bolt guide in the driving direction and itself constitutes the pressing sensor.

In its setting-ready position, a securing element designed as a nail (105) is arranged behind the bolt guide and in front of a piston of the work tool, which is not illustrated and which, in order to drive the nail (105) into the substructure, has been pushed towards the nail and led into a piston guide (106). The nail (105) is, together with additional nails, held in a ribbon (107) made especially of plastic material, which is received by a cartridge (not shown) and conveyed towards the guide channel, i.e., towards the reader in FIG. 7, by a feed device arranged in one of the cartridges, such that the nails are conveyed one after the other into the setting-ready position.

A complete feed-delay device bearing the number (110) includes the lever (111), which includes a control element (112) with a control face (113) opposite to the driving direction (103), and the lever is stored on the holder (101) and can be rotated over a pin (114). In an exemplary embodiment not illustrated, the lever is similarly designed as a pivoting lever and/or as a pushing lever, which is, for example, able to be pushed as a carriage on the holder. For activating the control element (112), the pressing bracket (104) has an activation element (108) projecting in the driving direction (103).

FIG. 8 shows the nib (100) of the work tool with the feed-delay device (110) in a release position, if the work tool is not pressed onto a substructure and the piston is resting in its starting position, and, for example, a combustion chamber of the work tool (not shown) has collapsed. For the sake of clarity, the guide channel is not illustrated. The activation element (108) is engaged over the control face (113) with the control element (112) of the lever (111), which is thus held in the position shown.

FIG. 9 shows the nib (100) of the work tool with the feed-delay device (110) in a blocking position, if the work tool is pressed onto a substructure, and, for example, the combustion chamber of the work tool (not shown) is expanded. The guide channel, which is not illustrated, has pushed the pressing bracket (104) against the driving direction (103), i.e., to the right in the illustration. In doing so, the activation element (108) is disengaged from the control element (112). A spring element (not shown), for example a torsion spring, exerts a clockwise pre-stress on the lever (111), such that the control element (112) in FIG. 9 moves upwards.

FIG. 10 is a perspective view of the nib (100) of the work tool with the feed-delay device (110) in the release position according to FIG. 8. The ribbon (107) with the nails (105) is conveyed into the guide channel (not shown) from below. The activation element (108) is once again engaged over the control face (113) with the control element (112) of the lever (111), which is thus held in the position shown. The lever (111) has a toothed contact surface (115) for attachment to the nail (105) or the ribbon (107), from which, however, it is separated in the release position of the feed-delay device (110) as shown. The conveying of the nail (105) into the guide channel (not shown) is thus allowed.

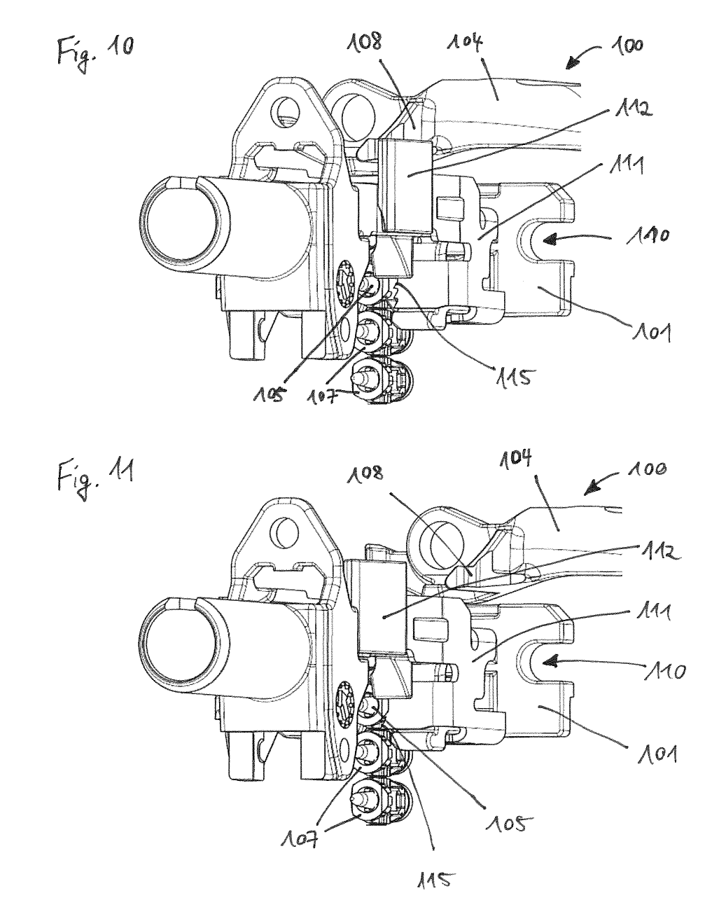

FIG. 11 is a perspective view of the nib (100) of the work tool with the feed-delay device (110) in the blocking position according to FIG. 9. Thus the activation element (108) is once again disengaged from the control element (112), such that the control element (112) has moved to the left due to the pre-stress of the spring element (not shown) in FIG. 11. The contact surface (115) now lies closely to the nail (105) and/or ribbon (107), such that a conveying of the nail (105) into the guide channel (not shown) is blocked in the blocking position of the feed-delay device (110) as shown. The detection device allows a movement of the pressing bracket (104) back into the position according to FIG. 10 only when the piston is resting in its starting position. This ensures that the feeding of the securing element is delayed until, if applicable, any back-and-forth movement of the piston has terminated.

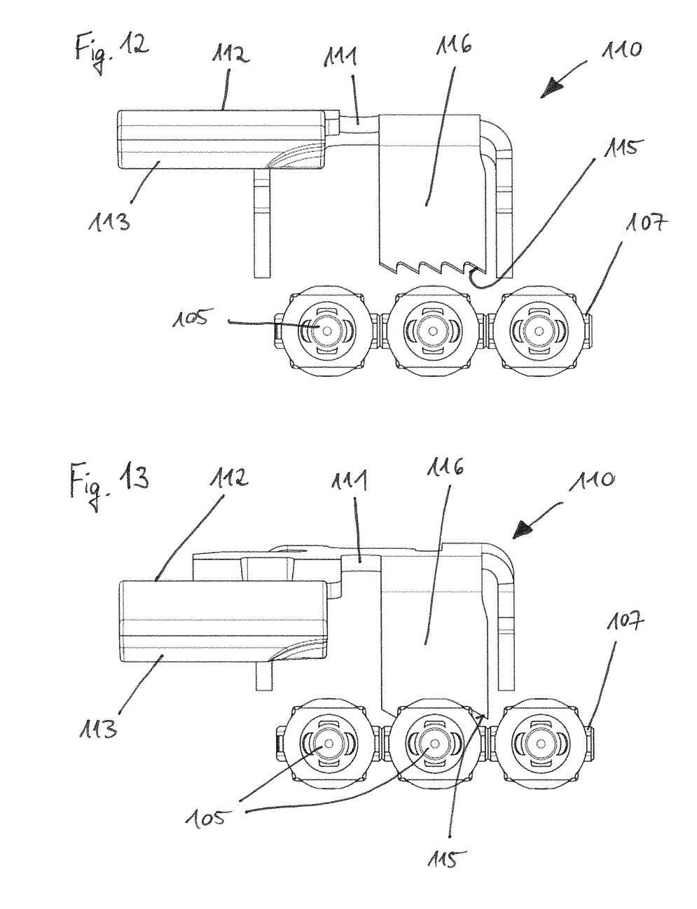

FIG. 12 shows the feed-delay device (110) with the lever (111) in the release position according to FIG. 8 and FIG. 10 in the driving direction. The ribbon (107) with the nails (105) is conveyed in a leftwards direction into the guide channel (not shown), in which the left nail (105) in FIG. 12 is already located in the setting-ready position. The lever (111) includes a contact element (116), which has the toothed contact surface (115). In the illustrated release position of the feed-delay device (110), the contact surface (115) is separated from the nails (105) and the ribbon (107), such that the conveying of the nail (105) into the guide channel (not shown) is allowed.

FIG. 13 shows the feed-delay device (110) with the lever (111) in the blocking position according to FIG. 9 and FIG. 11 in the driving direction. The contact element (116) lies closely with its toothed contact surface (115) to the ribbon (107), such that the teeth of the serration partially grasp into the ribbon (107) positively. In doing so, the ribbon is clenched by the force of the spring element (not shown) against a supporting element (also not shown), which is connected, for example, to the holder or the housing of the work tool or the cartridge. In the illustrated blocking position of the feed-delay device (110), a conveying of the second nail (105) in FIG. 13 in a leftwards direction into the guide channel (not shown) is thus blocked, even if the left nail is no longer present after a driving process and the piston has released the guide channel. In exemplary embodiments that are not illustrated, the third, fourth or fifth nail or the ribbon is clenched to a position between two nails. The serration of the contact surface (115) has a preferred direction (see FIG. 12), such that the ribbon (107) is able to be taken out of the illustrated position manually to the right despite the blocking position, for example in the case of a malfunction of the work tool. In exemplary embodiments that are not illustrated, the contact surface is smooth or slightly curved and only lies force-closed to the securing element or the ribbon.

The described feed delay is not dependent upon the speed with which the user lifts up the work tool from the substructure and is thus not subject to the operating behavior of the user. Moreover, the guide channel can be moved independently of the feed-delay device, for example, upon lifting from the substructure due to a decoupling from the rest of the work tool remaining on the substructure, through which the driving quality is improved in certain conditions. Otherwise, the guide channel is an easily configurable wear part. Further, the feed delay is not dependent upon the type of piston pushing and can also be utilized with work tools with non-collapsing combustion chambers.

1.-15. (canceled)

16. A work tool for driving a securing element into a substructure, comprising:
a guide channel for the securing element;
a piston that is pushable towards the securing element proceeding from a starting position in which the piston is at rest, so as to transmit energy to the securing element arranged in the guide channel;
a feed device for conveying the securing element into the guide channel; and
a feed-delay device for delaying the securing element being conveyed into the guide channel until the piston has returned into the starting position following a driving process.

17. The work tool according to claim 16, wherein the feed-delay device has:
a release position that allows the securing element to be conveyed into the guide channel when the piston is arranged in the starting position; and
a blocking position that blocks the conveying of the securing element into the guide channel when the piston is arranged outside of the starting position.

18. The work tool according to claim 16, further comprising a detection device for determining whether the piston is arranged in the starting position.

19. The work tool according to claim 16, further comprising a drive device for pushing the piston towards the securing element and a trip device that, when activated, triggers the pushing of the piston towards the securing element.

20. The work tool according to claim 16, further comprising a pressing device, wherein the pressing device determines whether the work tool is pressed onto a substructure and is arranged in a pressing position when the work tool is pressed onto a substructure.

21. The work tool according to claim 20, wherein the pressing device allows the pushing of the piston towards the securing element only in the pressing position.

22. The work tool according to claim 20, wherein the drive device has a combustion chamber that is expanded by the pressing device when the work tool is pressed onto a substructure.

23. The work tool according to claim 18, wherein after a driving process, the detection device only allows the collapsing of the expanded combustion chamber when the piston is arranged in the starting position, and the detection device blocks the collapsing of the expanded combustion chamber when the piston is not arranged in the starting position.

24. The work tool according to claim 16, wherein the feed-delay device is moved from the release position into the blocking position when the work tool is pressed onto a substructure and/or when the combustion chamber is expanded.

25. The work tool according to claim 22, wherein the feed-delay device is moved from the blocking position into the release position when the combustion chamber collapses.

26. The work tool according to claim 16, further comprising a cartridge for receiving the securing element, for which the feed device is provided to convey the securing element from the cartridge into the guide channel.

27. The work tool according to claim 16, wherein the feed-delay device has a lever, the lever in the blocking position is projected into the conveying path or lies flat against the securing element, and the lever in the release position is separated from the conveying path and the securing element.

28. The work tool according to claim 27, wherein the lever has a contact surface for force-closed and/or form-closed contact against the securing element.

29. The work tool according to claim 27, wherein the lever is configured as an especially spring-loaded pivoting lever.

30. The work tool according to claim 27, wherein the lever is rotatable on an axis of rotation against a housing and/or a nib of the work tool.

31. The work tool according to claim 22, wherein after a driving process, the detection device only allows the collapsing of the expanded combustion chamber when the piston is arranged in the starting position, and the detection device blocks the collapsing of the expanded combustion chamber when the piston is not arranged in the starting position.

32. The work tool according to claim 30, wherein the lever is mounted on the guide channel or on the cartridge.
